(19) United States
(12) Patent Application Publication
(10) Pub. No.: US 2011/0229837 A1
(43) Pub. Date: Sep. 22, 2011

(54) Wafer Heating Apparatus, Electrostatic Chuck, and Method for Manufacturing Wafer Heating Apparatus

(75) Inventor: Yasushi Migita, Kirishima-shi (JP)

(73) Assignee: KYOCERA CORPORATION, Kyoto-shi, Kyoto (JP)

(21) Appl. No.: 13/131,014

(22) PCT Filed: Nov. 13, 2009
(86) PCT No.: PCT/JP2009/069359

§ 371 Date: May 24, 2011

(30) Foreign Application Priority Data
Nov. 25, 2008 (JP) 2008-299080

(51) Int. Cl. F24J 3/00; B32B 37/12; B32B 37/10

(52) U.S. Cl. 432/227; 156/60

(57) ABSTRACT

A wafer heating apparatus includes a base member having an upper surface which is flat; an insulating layer having a heater electrode embedded therein; a uniformly heating plate bonded to an upper surface of the insulating layer with an upper surface thereof being closer to a wafer; and a bonding layer made of a filler-containing resin, configured to bond a lower surface of the insulating layer to the upper surface of the base member. The bonding layer includes at least two layers of a first bonding layer on a base member side and a second bonding layer contacted with the insulating layer. The second bonding layer contains fillers with a flat-shape. The fillers are arranged to lie flat along a planar direction of the second bonding layer.

### TECHNICAL FIELD

The present invention relates to a wafer heating apparatus for use in a film-forming apparatus, an etching apparatus, and so forth adapted to a CVD method, a PVD method, and a sputtering method, as well as to an electrostatic chuck employing the wafer heating apparatus and a method for manufacturing a wafer heating apparatus.

### BACKGROUND ART

Heretofore it has been customary for a wafer heating apparatus for heating for example a semiconductor wafer or a glass wafer in a supported state to be used in a film-forming apparatus as well as an etching apparatus adapted to a CVD method, a PVD method, and a sputtering method.

In the case of heating a semiconductor wafer or the like by using such a wafer heating apparatus, it is required that variations in the heat applied to the semiconductor wafer or the like be reduced. This has created a demand for the enhancement of thermal uniformity in a bonding material for bonding a base body (base member) constituting the wafer heating apparatus with an insulator.

With this in view, in Patent literature 1, there is presented a semiconductor support apparatus comprising a metal member and a bonding layer for bonding a semiconductor support member with the metal member, in which the bonding layer is made of an adhesive sheet, and the adhesive sheet contains a resin matrix and fillers dispersed in the resin matrix.

Patent literature 1: Japanese Unexamined Patent Publication JP-A 2006-13302

### DISCLOSURE OF INVENTION

### Technical Problem

However, in the semiconductor support apparatus as presented in Patent literature 1, although the thermal conductivity of the bonding layer can be enhanced by utilizing the filler-added adhesive sheet for the bonding layer, there are restrictions on the amount of fillers to be added. This makes it impossible to achieve further enhancement in thermal uniformity.

Accordingly, the invention has been made in view of the problem associated with the conventional art as mentioned supra, and its object is to provide a wafer heating apparatus which affords enhanced thermal uniformity.

### Solution to Problem

The invention provides a wafer heating apparatus comprising:

a base member comprising an upper surface which is flat;

an insulating layer comprising a heater electrode embedded therein;

a uniform heating plate bonded to an upper surface of the insulating layer with an upper surface thereof being closer to a wafer; and

a bonding layer made of a filler-containing resin, configured to bond a lower surface of the insulating layer to the upper surface of the base member, wherein

the bonding layer comprises at least two layers of a first bonding layer on a base member side and a second bonding layer contacted with the insulating layer, and

the second bonding layer contains fillers with a flat-shape, the fillers being arranged to lie flat along a planar direction of the second bonding layer.

Moreover, in the wafer heating apparatus of the invention, it is preferable that a ratio of an area of the fillers with a flat-shape constitutes 50 to 90% to an area of the second bonding layer when the second bonding layer is viewed in a plan view.

Moreover, in the wafer heating apparatus of the invention, it is preferable that a density of the fillers in the second bonding layer is higher than a density of fillers in the first bonding layer.

Moreover, in the wafer heating apparatus of the invention, it is preferable that the fillers with a flat-shape are arranged to overlap in part each other.

The invention provides an electrostatic chuck comprising:

the wafer heating apparatus as mentioned above; and

a ceramic member which is bonded to the upper surface of the uniform heating plate, comprises an adsorption electrode embedded therein and an upper surface thereof configured to be a wafer placement surface.

The invention provides a method for manufacturing a wafer heating apparatus comprising:

forming a first bonding layer by applying a first adhesive made of a resin containing fillers to an upper surface of a base member, the upper surface configured to be flat, and then curing the first adhesive;

applying a second adhesive made of a resin containing fillers with a flat-shape to an upper surface of the first bonding layer;

placing an insulating layer comprising a heater electrode embedded therein on the second adhesive, and then keeping the insulating layer and the second adhesive in intimate contact with each other in a vacuum environment;

curing the second adhesive while applying pressure from an upper surface of the insulating layer in an atmosphere environment; and

bonding a uniform heating plate to the upper surface of the insulating layer.

### Advantageous Effects of Invention

According to the invention, a wafer heating apparatus comprises: a base member comprising an upper surface which is flat; an insulating layer comprising a heater electrode embedded therein; a uniform heating plate bonded to an upper surface of the insulating layer with an upper surface thereof being closer to a wafer; and a bonding layer made of a filler-containing resin, configured to bond a lower surface of the insulating layer to the upper surface of the base member. The bonding layer comprises at least two layers of a first bonding layer on a base member side and a second bonding layer contacted with the insulating layer. The second bonding layer contains fillers with a flat-shape, and the fillers are arranged to lie flat along a planar direction of the second bonding layer. In this construction, the second bonding layer is capable of efficient diffusion of heat in the planar direction by virtue of the fillers with a flat-shape arranged to lie flat along the planar direction. This makes it possible to render the thermal distribution in the uniform heating plate even more uniform.

Moreover, since the first bonding layer and the second bonding layer can be made different from each other in terms of filler distribution, it follows that the first bonding layer and the second bonding layer can have different thermal conductivities. For example, when the bonding layer includes the second bonding layer having a relatively high thermal conductivity and the first bonding layer having a relatively low thermal conductivity, then the thermal uniformity of the bonding layer can be enhanced, and also thermal losses resulting from heat dissipation can be suppressed. This is because, with the provision of the second bonding layer having a relatively high thermal conductivity, the thermal uniformity of the bonding layer can be enhanced, and also, with the provision of the first bonding layer having a relatively low thermal conductivity, thermal losses resulting from heat dissipation from a lateral surface of the bonding layer can be suppressed.

Moreover, since the bonding layer takes on a stacked structure comprising the first bonding layer and the second bonding layer, it is possible to reduce variations in bondability between the insulating layer and the bonding layer.

Moreover, in the wafer heating apparatus of the invention, a ratio of an area of the fillers with a flat-shape constitutes 50 to 90% to an area of the second bonding layer when the second bonding layer is viewed in a plan view. In this case, the distribution of the fillers can be rendered uniform, and variations in heat conduction in the bonding layer can be reduced, with consequent uniformity in heat diffusion. In addition, adhesive components other than the fillers can be retained to exhibit bonding strength.

Moreover, in the wafer heating apparatus of the invention, a density of the fillers in the second bonding layer is higher than a density of fillers in the first bonding layer. In this case, in the second bonding layer, heat can be diffused in the planar direction more efficiently. This makes it possible to render the thermal distribution in the uniform heating plate even more uniform.

Moreover, in the wafer heating apparatus of the invention, the fillers with a flat-shape are arranged to overlap in part each other. In this case, in the second bonding layer, heat can be diffused in the planar direction efficiently. This makes it possible to render the thermal distribution in the uniform heating plate even more uniform.

An electrostatic chuck of the invention comprises: the wafer heating apparatus as mentioned above; and a ceramic member which is bonded to the upper surface of the uniform heating plate, and comprises an adsorption electrode embedded therein and an upper surface thereof configured to be a wafer placement surface. In this construction, with use of the uniform heating plate which exhibits more uniform thermal distribution, a wafer can be heated uniformly while being adsorbed onto the wafer placement surface.

A method for manufacturing a wafer heating apparatus of the invention comprises: forming a first bonding layer by applying a first adhesive made of a resin containing fillers to an upper surface of a base member, the upper surface configured to be flat, and then curing the first adhesive; applying a second adhesive made of a resin containing fillers with a flat-shape to an upper surface of the first bonding layer; placing an insulating layer comprising a heater electrode embedded therein on the second adhesive, and then keeping the insulating layer and the second adhesive in intimate contact with each other in a vacuum environment; curing the second adhesive while applying pressure from an upper surface of the insulating layer in an atmosphere environment; and bonding a uniform heating plate to the upper surface of the insulating layer. According to this method, the second adhesive is cured under application of pressure, wherefore the fillers with a flat-shape can be configured to lie flat along the planar direction of the second bonding layer. As a result, it is possible to manufacture the wafer heating apparatus in which the thermal distribution in the uniform heating plate can be rendered even more uniform.

### BRIEF DESCRIPTION OF DRAWINGS

FIG. 1 is a perspective view showing a wafer heating apparatus according to an embodiment of the invention;

FIG. 2 is a vertical sectional view of the wafer heating apparatus of FIG. 1;

FIGS. 3(a) and 3(b) show bonding layers of the wafer heating apparatus according to the embodiment of the invention, wherein FIG. 3(a) is an enlarged vertical sectional view of a second bonding layer, and FIG. 3(b) is an enlarged vertical sectional view of a first bonding layer;

FIG. 4 is a vertical sectional view showing an electrostatic chuck employing the wafer heating apparatus according to an embodiment of the invention; and

FIGS. 5(a) through 5(d) are fragmentary vertical sectional views of the wafer heating apparatus, illustrating a method for manufacturing the wafer heating apparatus according to an embodiment of the invention on a step-by-step basis.

### BEST MODE FOR CARRYING OUT THE INVENTION

Hereinafter, a wafer heating apparatus, an electrostatic chuck, and a method for manufacturing a wafer heating apparatus according to the invention will be described in detail by way of embodiments with reference to the drawings.

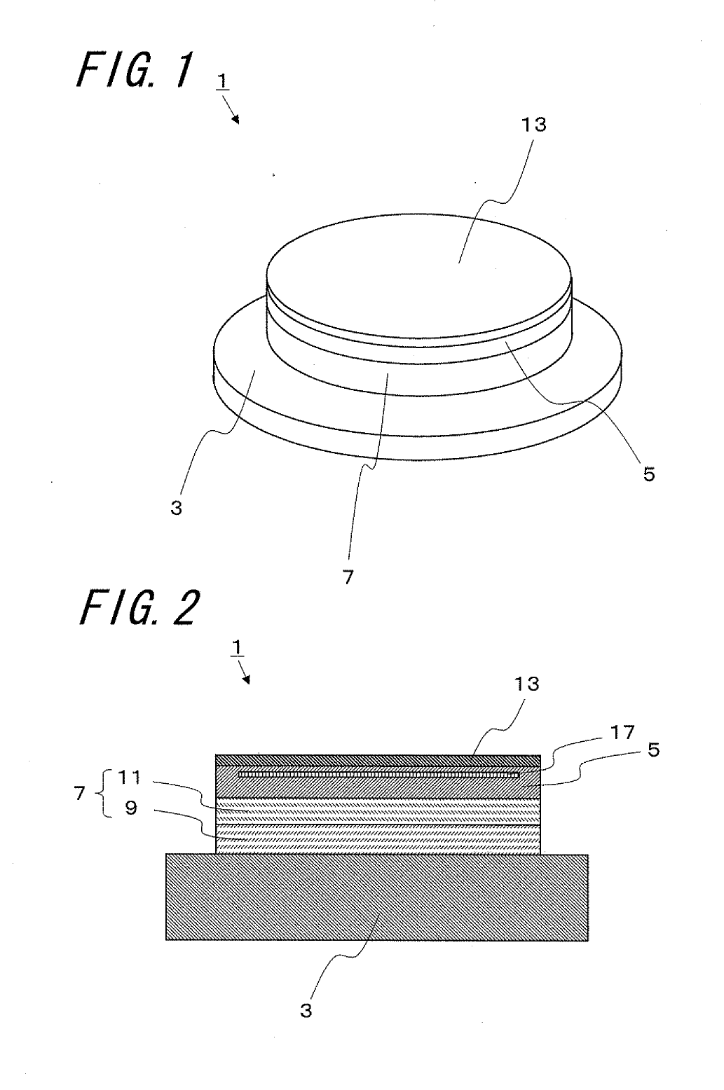

As shown in FIGS. 1 and 2, a wafer heating apparatus 1 according to an embodiment comprises: a base member 3 comprising an upper surface which is flat; an insulating layer 5 comprising a heater electrode embedded therein; a uniform heating plate 13 bonded to an upper surface of the insulating layer 5 with an upper surface thereof being closer to a wafer; and a bonding layer 7 made of a filler-containing resin, configured to bond a lower surface of the insulating layer 5 to the upper surface of the base member 3. The bonding layer 7 comprises at least two layers of a first bonding layer 9 on a base member 3 side and a second bonding layer 11 contacted with the insulating layer 5. The second bonding layer 11 contains fillers with a flat-shape, and the fillers are arranged to lie flat along a planar direction of the second bonding layer 11.

In this construction, the second bonding layer 11 is capable of efficient diffusion of heat in the planar direction by virtue of the fillers with a flat-shape arranged to lie flat along the planar direction. This makes it possible to render the thermal distribution in the uniform heating plate 13 even more uniform.

Moreover, since the first bonding layer 9 and the second bonding layer 11 can be made different from each other in terms of filler distribution, it follows that the first bonding layer 9 and the second bonding layer 11 can have different thermal conductivities. For example, when the bonding layer 7 includes the second bonding layer 11 having a relatively high thermal conductivity and the first bonding layer 9 having a relatively low thermal conductivity, then the thermal uniformity of the bonding layer 7 can be enhanced, and also thermal losses resulting from heat dissipation can be suppressed. This is because, with the provision of the second bonding layer 11 having a relatively high thermal conductivity, the thermal uniformity of the bonding layer 7 can be enhanced, and also, with the provision of the first bonding layer 9 having a relatively low thermal conductivity, thermal losses resulting from heat dissipation from a lateral surface of the bonding layer 7 can be suppressed.

Further, the bonding layer 7 takes on a stacked structure comprising the first bonding layer 9 and the second bonding layer 11, wherefore variations in bondability between the insulating layer 5 and the bonding layer 7 can be reduced.

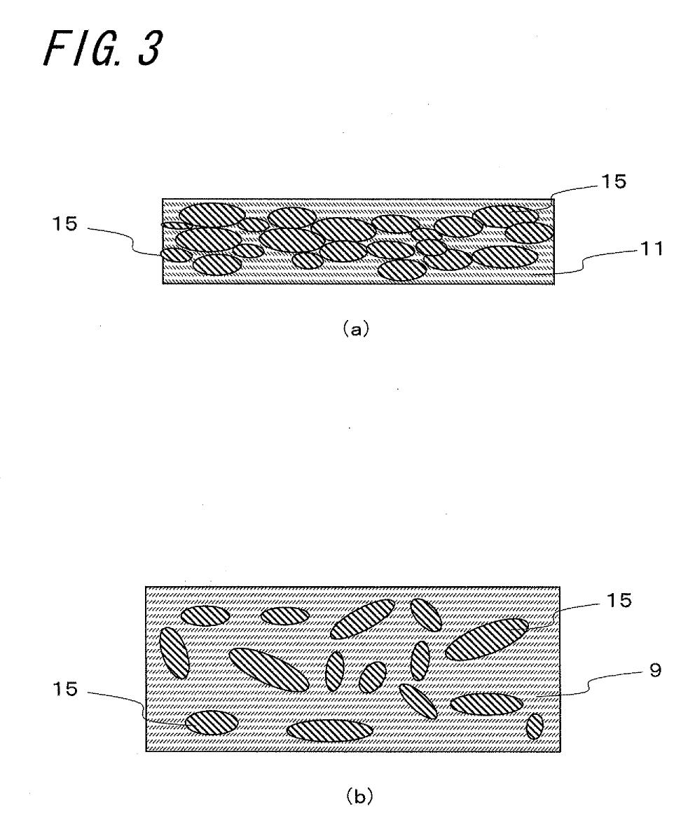

As shown in FIG. 3(a), the second bonding layer 11 contains fillers 15 with a flat-shape. The fillers 15 are arranged to lie flat along the planar direction of the second bonding layer 11. Accordingly, in the bonding layer 7 contacted with the insulating layer 5, heat can be diffused in a direction perpendicular to a direction of thickness of the bonding layer 7 (the planar direction) through the fillers 15. As a result, the thermal distribution in the uniform heating plate 13 having a heater surface configured to heat a semiconductor wafer or the like can be rendered even more uniform.

FIG. 3(b) is a vertical sectional view of the first bonding layer 9. The fillers 15 with a flat-shape contained in the first bonding layer 9 are arranged in random orientations. In this case, since the bonding layer 7 includes the second bonding layer 11 having a relatively high thermal conductivity and the first bonding layer 9 having a relatively low thermal conductivity, it is possible to enhance the thermal uniformity of the bonding layer 7, as well as to suppress thermal losses resulting from heat dissipation. That is, with the provision of the second bonding layer 11 having a relatively high thermal conductivity, the thermal uniformity of the bonding layer 7 can be enhanced, and also, with the provision of the first bonding layer 9 having a relatively low thermal conductivity, thermal losses resulting from heat dissipation from a lateral surface of the bonding layer 7 can be suppressed.

As materials for the base member 3 constituting the wafer heating apparatus 1 of the embodiment, metals including aluminum, an aluminum alloy such as a Al—Mg—Si-based alloy (for example, an aluminum alloy bearing an aluminum-alloy standard number of 6061 (according to JIS H 4000, for example)), stainless steel, and cemented carbide containing tungsten or the like; or a composite of such a metal and ceramics can be used. As ceramics, to be specific, Al₂O₃, SiC, AlN, Si₃N₄, or the like can be used. In the interest of resistance to corrosion, Al₂O₃ and AlN are particularly desirable for use as the base member 3.

As materials for the insulating layer 5 having a heater electrode embedded therein, a resin which exhibits heat resistance and dielectric strength such as polyimide; and an insulator such as ceramics are preferable.

As materials for the uniform heating plate 13 whose upper surface is closer to a wafer, metals having high thermal conductivity such as aluminum and copper; an alloy of such metals; or ceramics such as AlN can be used.

The bonding layer 7 may be made of any given material so long as it has the capability of bonding the insulating layer 5 with the base member 3. For example, an adhesive resin, and more specifically a silicone resin, an epoxy resin, an acrylic resin, or the like can be used. Moreover, it is preferable that a plurality of layers constituting the bonding layer 7 contain substantially the same component. This makes it possible to enhance the bondability between the layers constituting the bonding layer 7, and thereby keep the bonding layer 7 in shape with stability.

The bonding layer 7 is preferably composed of two or more layers. This is for the following reasons: 1) in order to heat a wafer surface and dissipate an amount of heat generated by the heater electrode to the base member 3 efficiently, the bonding layer 7 needs to have a certain extent of thickness; 2) a further increase in the thickness of the bonding layer 7 will be necessary depending on the degree of operating temperature; and 3) since there is a need to dissipate heat uniformly to the base member 3 for uniform application of heat to the wafer surface, it is necessary to even out variations in the thickness of the bonding layer 7. Therefore, by forming the bonding layer 7 of two or more layers, it is possible to render the thickness of the bonding layer 7 uniform, as well as even out layer thickness variations.

The bonding layer 7 contains the fillers 15 for the enhancement of thermal conductivity. The fillers 15 each have a flat-shape. The fillers 15 contained in the second bonding layer 11 contacted with the insulating layer 5 are arranged to lie flat along the planar direction. Such a filler arrangement can be obtained as follows. In order to attain uniform thickness and even out thickness variations, the base member 3 and the insulating layer 5 are bonded to each other under pressure. At this time, the fillers 15 are forced to lie flat along the planar direction correspondingly.

The filler 15 may be made of any given material so long as it has a thermal conductivity which is equal to or greater than the thermal conductivity of the insulating layer 5 as well as the base member 3. For example, a metal or ceramic material can be used. To be specific, in the case of forming the filler 15 of metal, aluminum or an aluminum alloy can be used. In the case of forming the filler 15 of ceramics, Al₂O₃, SiC, AlN, or Si₃N₄, can be used.

It is preferable that the flat surface-based average particle size (average particle width) of the fillers 15 falls in a range of about 50 to 100 μm. Where the average value falls within the prescribed range, the fillers 15 can be configured to lie flat along the planar direction efficiently at the time of bonding the second bonding layer 11 under pressure.

It is preferable that the thickness between the opposite flat surfaces of the filler 15 falls in a range of about 20 to 50 μm. Where the thickness falls within the prescribed range, the fillers 15 can be distributed naturally within the range of thickness of the second bonding layer 11.

Moreover, it is preferable that, in the bonding layer 7 containing the fillers 15, the thickness of each layer constituting the bonding layer 7 is greater than the average particle size (or the average particle width) of the fillers 15. This makes it possible to suppress variations in the thickness of the bonding layer 7 ascribable to the fillers 15 per se. To be specific, the thickness of each layer constituting the bonding layer 7 is preferably set at or above 30 μm.

Further, it is preferable that a ratio of an area of the fillers 15 with a flat-shape constitutes 50 to 90% to an area of the second bonding layer 11 when the second bonding layer 11 is viewed in a plan view. This is because a high content of the fillers 15 helps facilitate diffusion of the heat from the heater electrode 17 in a direction perpendicular to the direction of thickness of the bonding layer 7. Where the ratio of the area of the fillers falls within a range of 50 to 90%, the distribution of the fillers 15 can be rendered uniform, and variations in thermal conduction in the bonding layer 7 can be reduced, with consequent uniformity in heat diffusion. Also, the bonding components other than the fillers 15 can be retained to exhibit bonding strength.

For example, the ratio of the area of the fillers 15 can be assessed in the following manner. To begin with, the wafer heating apparatus 1 is cut by a diamond cutter or the like to obtain a cross section which is perpendicular to the main surface of the insulating layer 5 and includes the first bonding layer 9 and the second bonding layer 11. On the basis of the cross section, the sum total of cross-sectional areas of the fillers 15 contained in the first bonding layer 9 and the sum total of cross-sectional areas of the fillers 15 contained in the second bonding layer 11 are measured respectively. Then, the sum total of cross-sectional areas of the fillers 15 in the respective bonding layers is divided by the cross-sectional area of the entirety of the respective bonding layers. The value thus obtained can be defined as the ratio of the area of the fillers 15 for the case where the second bonding layer 11 is viewed in a plan view.

It is also preferable that a density of the fillers 15 in the second bonding layer 11 is higher than a density of the fillers 15 in the first bonding layer 9. In this case, in the second bonding layer 11, heat is allowed to diffuse in the planar direction more efficiently, wherefore the thermal distribution in the uniform heating plate 13 can be rendered even more uniform. It is advisable that a density of the fillers 15 in the second bonding layer 11 is about twice or more as high as a density of the fillers 15 in the first bonding layer 9. Where the above density fulfills the prescribed condition, in the second bonding layer 11, heat is allowed to diffuse in the planar direction even more efficiently. Moreover, in this case, it is advisable that, for example, a density of the fillers 15 in the second bonding layer 11 falls in a range of about 3.0 to 4.0 g/cm³, whereas a density of the fillers 15 in the first bonding layer 9 falls in a range of about 1.0 to 2.0 g/cm³.

The following is an example of methods for rendering the density of the fillers 15 in the second bonding layer 11 higher than the density of the fillers 15 in the first bonding layer 9. That is, in order to provide a certain extent of thickness, the first bonding layer 9 is formed in advance, prior to the formation of the insulating layer 5, by applying its constituent material to the upper surface of the base member 3 and performing curing by means of heating or the like. After that, the second bonding layer 11 is formed thereon, and the insulating layer 5 and the base member 3 are bonded to each other, while applying pressure to suppress thickness variations as has already been described. As a consequence, a flowable adhesive component is forced out of a second adhesive which is to become the second bonding layer 11 during application of pressure, thereby forming the second bonding layer 11 having a high filler density.

Moreover, as shown in FIG. 3(a), in the second bonding layer 11, the fillers 15 with a flat-shape are preferably arranged to overlap in part each other. In this case, in the second bonding layer 11, heat is allowed to diffuse in the planar direction efficiently, wherefore the thermal distribution in the uniform heating plate 13 can be rendered more uniform. As a specific example of arrangement of the fillers 15, the fillers 15 with a substantially flat-shape are arranged to lie flat, with their less-thick end portions overlapping each other.

The following is an example of methods for arranging the fillers 15 with a flat-shape contained in the second bonding layer 11 to overlap in part each other. That is, as has already been described, at the time of bonding the insulating layer 5 with the base member 3, the second bonding layer 11 is subjected to application of pressure, whereupon the fillers. 15 with a flat-shape are arranged to lie flat along the planar direction while increasing the density of the fillers contained in the second bonding layer 11. In this way, the fillers 15 with a flat-shape can be configured to overlap each other.

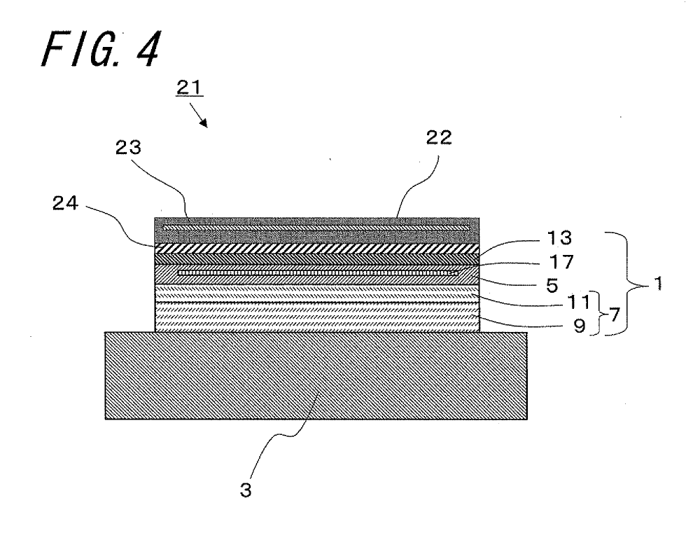

Moreover, as shown in FIG. 4, an electrostatic chuck according to an embodiment comprises the wafer heating apparatus 1 having the aforestated structure and a ceramic member 22 which is bonded to the upper surface of the uniform heating plate 13, and comprises an adsorption electrode 23 embedded therein and an upper surface thereof configured to be a wafer placement surface. In this construction, a wafer can be heated uniformly while being adsorbed onto the wafer placement surface.

As the material of formation of the ceramic member 22, to be specific, ceramics composed predominantly of alumina, silicon nitride, aluminum nitride, boron carbide, or the like can be used. Among them, ceramics composed predominantly of aluminum nitride is suitable for a material of the platy ceramic member 22, because it exhibits higher thermal conductivity as compared with other ceramics, and has high corrosion resistance and plasma resistance to highly corrosive halogen gas and plasma.

As materials for the adsorption electrode 23 which is embedded in the ceramic member 22, a high melting-point metal made of an element belonging to Group 6a on the periodic table such as tungsten (W) or molybdenum (Mo), or an element belonging to Group 4a on the periodic table such as Ti; an alloy of such elements; or electrical conductive ceramics such as WC, MoC or TiN can be used. The aforementioned metal, alloy, and electrical conductive ceramics have a thermal expansion coefficient which is substantially equal to the thermal expansion coefficient of ceramics constituting the platy ceramic member 22. Therefore, with use of such a material, the platy ceramic member 22 can be protected from warpage or damage during manufacturing and heat generation as well, and a break will never occur even under heat generation at a temperature as high as about 300° C.

In bonding the wafer heating apparatus 1 of this embodiment with the ceramic member 22, it is desirable to use an adhesive 24 which is heat-resistant and becomes rubbery to have high extensibility after curing, such as a silicone resin adhesive. The use of the adhesive 24 made of a silicone resin adhesive or the like makes it possible to suppress peeling caused by quality degradation of the adhesive 24 due to heat generated during heating of a wafer, and is also effective in preventing warpage of the wafer placement surface of the ceramic member 22 caused by the difference in thermal expansion between the adhesive 24 and the ceramic member 22.

The adhesive 24 preferably has a thickness in a range of about 20 to 120 μm. Where the thickness falls within the prescribed range, the bonding capability of the adhesive 24 can be maintained, and also the heat from the heater electrode 17 can be transmitted toward the ceramic member 22 efficiently.

Next, a method for manufacturing a wafer heating apparatus according to an embodiment will be described below.

The method for manufacturing the wafer heating apparatus 1 comprises: forming the first bonding layer 9 by applying a first adhesive made of a resin containing the fillers 15 to the upper surface of the base member 3, the upper surface configured to be flat, and then curing the first adhesive; applying the second adhesive made of a resin containing the fillers 15 with a flat-shape to the upper surface of the first bonding layer 9; placing the insulating layer 5 comprising the heater electrode 17 embedded therein on the second adhesive, and then keeping the insulating layer 5 and the second adhesive in intimate contact with each other in a vacuum environment; curing the second adhesive while applying pressure from the upper surface of the insulating layer 5 in an atmosphere environment; and bonding the uniform heating plate 13 to the upper surface of the insulating layer 5.

According to this method, the second adhesive is cured under application of pressure, wherefore the fillers 15 with a flat-shape can be configured to lie flat along the planar direction of the second bonding layer 11. As a consequence, it is possible to manufacture the wafer heating apparatus 1 in which the thermal distribution in the uniform heating plate 13 can be rendered more uniform.

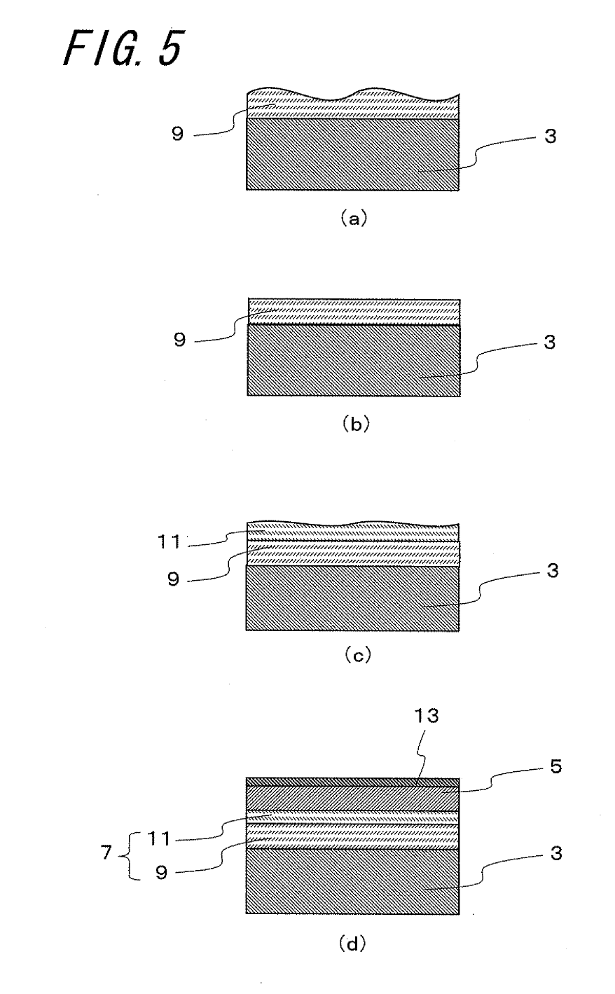

To begin with, as shown in FIG. 5(a), the first bonding layer 9 is formed on the upper surface of the base member 3. As the method therefor, there are a method of printing the first bonding layer to the upper surface of the base member 3 by means of printing plate or the like, a method of providing a frame configured to conform to the shape of the upper surface and pouring the first adhesive into the frame, and so forth. At this time, air finds its way into the interface between the base member 3 and the first adhesive during the adhesive application, and the resulting air layer gives rise to problems such as impairment in thermal uniformity and occurrence of peeling. In order to remove the air layer, it is desirable to perform vacuum defoaming treatment after the application of the first adhesive.

In this case, as shown in FIG. 5(b), it is desirable to provide a step of planarizing a surface bearing the applied first adhesive for uniformity in the thickness of the first bonding layer 9. This makes it possible to reduce variations in the thickness of the first bonding layer 9 and thereby reduce variations in the thickness of the bonding layer 7.

As a method for planarizing the surface bearing the applied first adhesive, there is a method of printing the first adhesive to the surface by means of printing plate or the like, or a method of leveling the surface bearing the applied first adhesive flat by means of a straight edge or the like, and so forth. In addition, for example, there is a method of applying the first adhesive, then curing the first adhesive by means of application of heat or the like, and planarizing the surface of the first adhesive by removing surface asperities by means of machining operation such as grinding. It is noted that “planarizing” does not mean planarizing the surface of the first bonding layer 9 perfectly, but means making the surface asperities of the first bonding layer 9 smaller than before.

The first bonding layer 9 thus formed is cured in advance by means of application of heat or the like. By doing so, the fillers 15 are dispersed evenly in the first bonding layer 9. In the case of curing the first bonding layer 9 by application of heat, the heating temperature is set to fall in a range of about 80 to 120° C.

Next, as shown in FIG. 5(c), the second adhesive which is to become the second bonding layer 11 is applied onto the first bonding layer 9 in the same manner as described above. Then, the insulating layer 5 having the heater electrode 17 embedded therein is placed on the second adhesive, and the base member 3 and the insulating layer 5 having the heater electrode 17 embedded therein are brought into intimate contact with each other in a vacuum apparatus. In this way, air can be restrained from finding its way into the interface between the first bonding layer 9 and the second bonding layer 11, with consequent suppression of occurrence of a defect which impairs the thermal uniformity.

Next, as shown in FIG. 5(d), pressure is applied to the base member 3 and the insulating layer 5 having the heater electrode 17 embedded therein that are kept in intimate contact with each other, whereupon an excess of the adhesive component of the second adhesive is forced out of the second adhesive. At this time, the second adhesive layer is pressed down under the pressure, with the consequence that the fillers 15 with a flat-shape are arranged to lie flat along the planar direction of the second bonding layer 11.

As a method for applying pressure, there is a method of sandwiching the base member 3 and the insulating layer 5 having the heater electrode 17 embedded therein, now kept in intimate contact with each other in the form of a stacked body, with a press apparatus while pressure is applied vertically, or a method of applying pressure to the stacked body by tightening it with screws. At this time, as insurance against variations in the thickness of the bonding layer 7 caused by application of pressure, it is advisable to place a spacer on the lateral surface of the stacked body, as well as to insert a spacer having a height equal to the thickness of the bonding layer 7 into the bonding layer 7.

It is preferable that the pressure applied to the base member 3 and the insulating layer 5 kept in intimate contact with each other falls in a range of about 1000 to 2000 MPa. Where the pressure falls within the prescribed range, an excess of the adhesive component of the second adhesive is forced out of the second adhesive, and the fillers 15 with a flat-shape are easily arranged to lie flat along the planar direction of the second bonding layer 11.

Next, the second bonding layer 11 is cured by means of application of heat or the like. In the case of curing the second bonding layer 11 by application of heat, the heating temperature is set to fall in a range of about 80 to 120° C.

Then, the uniform heating plate 13 is placed on and bonded to the insulating layer 5 by means of adhesive bonding or the like. In this way, the wafer heating apparatus 1 can be fabricated.

### EXAMPLES

Hereinafter, an example of the wafer heating apparatus according to the invention will be described.

The wafer heating apparatus 1 having a structure as shown in FIGS. 1 and 2 was fabricated in the following manner.

To begin with, as a base member 3, there was prepared a disk-shaped member made of an aluminum alloy (Al—Mg—Si-based alloy) bearing an aluminum-alloy standard number of 6061 (according to JIS H 4000, for example), in which a cooling path capable of running a cooling medium such as water was formed. The base member 3 had the following dimensions: a diameter of 300 mm and a thickness of 35 mm. Moreover, the base member 3 had a terminal hole for passing electric current through the heater electrode 17 after bonding the insulating layer 5 having the heater electrode 17 embedded therein to the base member 3.

Next, the heater electrode 17 was formed of Inconel and in a predetermined pattern by means of etching or the like. The heater electrode 17 was then sandwiched sealingly by a sticky polyimide film under pressure. In this way, the disk-shaped insulating layer 5 having the heater electrode 17 embedded therein was formed. The insulating layer 5 had the following dimensions: a diameter of 300 mm and a thickness of 0.3 mm.

Next, the insulating layer 5 was fixedly bonded to a disk-shaped uniform heating plate 13 made of an aluminum alloy (Al—Mg—Si-based alloy) bearing an aluminum-alloy standard number of 6061 (according to JIS H 4000, for example) under pressure with use of an epoxy resin adhesive. The uniform heating plate 13 had the following dimensions: a diameter of 300 mm and a thickness of 1 mm.

Next, the base member 3 and the insulating layer 5 having the heater electrode 17 embedded therein were bonded to each other in the following manner. As the bonding layer 7 for bonding the base member 3 with the insulating layer 5, a silicone resin adhesive having high thermal conductivity which contains the fillers 15 was used. The thermal conductivity of the silicone resin adhesive was found to be 2.2 W/mK as the result of measurement using the laser flash technique.

The fillers 15 contained in the bonding layer 7 were each made of Al₂O₃ and configured to have a flat-shape (scale-shape), of which the flat surface-based average particle size was 80 μm, and the average thickness between flat surfaces was 30 μm.

The content of the fillers 15 contained in the bonding layer 7 was found to be about 45% by weight. However, in a second resin layer 11, the content of the fillers 15 becomes as high as about 70% by weight. This is because, as will hereafter be described, in a second adhesive which is to become the second resin layer 11, part of a silicone resin adhesive component is forced out of the second adhesive under pressure, with a consequent increase in the filler content.

As a first step, the silicone resin adhesive was applied to the upper surface of the base member 3, and subsequently vacuum defoaming treatment was carried out to remove bubbles remaining at the interface between the upper surface of the base member 3 and the silicone resin adhesive, as well as bubbles remaining in the inside of the silicone resin adhesive. A purpose of this treatment is to prevent the remaining bubbles from causing lack of uniformity in diffusion of heat from the heater electrode 17 that will lead to impairment of uniformity in wafer heating. Another purpose is to prevent the bubbles from causing deterioration in the adhesion between the base member 3 and the silicone resin adhesive that will lead to occurrence of peeling.

Next, the surface of the silicone resin adhesive coating was leveled flat by means of a straight edge. In this state, the silicone resin adhesive was cured by application of heat at a temperature of about 100° C., whereupon a first bonding layer 9 was formed.

Next, the same silicone resin adhesive was applied onto the first bonding layer 9 in the same manner as described above, and subsequently vacuum defoaming treatment was carried out. A purpose of this treatment is to remove bubbles remaining at the interface between the first bonding layer 9 and the silicone resin adhesive, as well as bubbles remaining in the inside of the silicone resin adhesive, as described above.

Next, the base member 3 and the insulating layer 5 having the heater electrode 17 embedded therein were bonded to each other via the silicone resin adhesive in a vacuum apparatus in the interest of prevention of the entry of bubbles during the bonding process.

Next, pressure was vertically applied to the base member 3 and the insulating layer 5, which now were integrally formed in a one-piece body through the bonding process, with a press apparatus under pressure of 1000 MPa, so that an excess of the silicone resin component was forced out of the one-piece body. At this time, in order to even out thickness variations in the bonding layer 7, a spacer whose heightwise dimension conformed to the required thickness of the bonding layer 7 was inserted between upper and lower press plates of the press apparatus. This made it possible to prevent excessive compression of the bonding layer 7 and thereby impart the desired thickness to the bonding layer 7.

Next, similarly, the silicone resin adhesive was cured by application of heat at a temperature of about 100° C., whereupon the second bonding layer 11 was formed. At that time, it was found that the thickness of the bonding layer 7 was about 1 mm and thickness variation was not greater than 20 μm. In addition, it was found that the thickness of the first bonding layer 9 was 900 μm and the thickness of the second bonding layer 11 was 100 μm.

Moreover, the ratio of an area of the fillers 15 with respect to the second bonding layer 11 as viewed in a plan view was measured in the following manner. Firstly, the wafer heating apparatus 1 was cut by a diamond cutter to obtain a cross section which is perpendicular to the main surface of the insulating layer 5 and includes the first bonding layer 9 and the second bonding layer 11. On the basis of the cross section, the sum total of cross-sectional areas of the fillers 15 contained in the first bonding layer 9 and the sum total of cross-sectional areas of the fillers 15 contained in the second bonding layer 11 were measured respectively. Then, the sum total of cross-sectional areas of the fillers 15 contained in the respective bonding layers was divided by the cross-sectional area of the entirety of the respective bonding layers. The value thus obtained was about 87%.

Further, it was found that a density of the fillers 15 in the first bonding layer 9 was 1.5 g/cm³ and a density of the fillers 15 in the second bonding layer 11 was 3.2 g/cm³.

In addition, the distribution of the fillers 15 was examined through the observation of the cross section of the bonding layer 7. The result showed that, in the second bonding layer 11, the fillers 15 with a flat-shape were arranged lie flat in the planar direction. Further, the result showed that some fillers 15 with a flat-shape overlapped in part each other. Such an arrangement of the fillers 15 resulted because the bonding layer 7 was pressed down by application of pressure in the press apparatus, with a consequent movement of the fillers 15.

The thermal uniformity of the uniform heating plate 13 of the wafer heating apparatus 1 thus fabricated was measured by means of a thermoviewer (product name: TH 3100mR manufactured by NEC Corporation). The result showed that the difference in temperature between the highest-temperature region and the lowest-temperature region was 2.7° C.

Meanwhile, by way of a comparative example, another wafer heating apparatus was fabricated in which the second bonding layer 11 was formed in a different method than that adopted in the foregoing example. That is, the second bonding layer 11 was formed as follows.

To begin with, in the same manner as described above, a silicone resin adhesive was applied onto the first bonding layer 9, and subsequently vacuum defoaming treatment was carried out.

Next, in order to render the thickness of the bonding layer 7 equal to the thickness of the bonding layer 7 of the foregoing wafer heating apparatus 1, the surface of the bonding layer 7 was leveled flat by means of a straight edge.

Next, the base member 3 and the insulating layer 5 having the heater electrode 17 embedded therein were bonded to each other in a vacuum apparatus.

Then, the silicone resin adhesive was cured by application of heat at a temperature of about 100° C. without application of pressure using a press apparatus. The second bonding layer 11 was formed in this way.

The ratio of the area of the fillers 15 with respect to the second bonding layer 11 thus obtained as viewed in a plan view was found to be about 48% through the measurement conducted in same manner as described above.

Moreover, it was found that a density of the fillers 15 in the first bonding layer 9 was 1.6 g/cm³, and a density of the fillers 15 in the second bonding layer 11 was 1.4 g/cm³.

Further, the distribution of the fillers 15 was examined through the observation of the cross section of the bonding layer 7. The result showed that, in each of the first bonding layer 9 and the second bonding layer 11, the fillers 15 were distributed in random orientations and positions.

The thermal uniformity of the wafer heating apparatus thus fabricated of the comparative example was measured by means of a thermoviewer (product name: TH 3100mR manufactured by NEC Corporation). The result showed that the difference in temperature between the highest-temperature region and the lowest-temperature region was 4.2° C.

It will thus be seen that, by forming the second bonding layer 11 under application of pressure, the fillers 15 can be configured to lie flat along the planar direction of the second bonding layer 11, and also the ratio of the area of the fillers 15 as viewed in a plan view can be increased, with consequent enhancement in thermal uniformity.

It should be understood that the application of the invention is not limited to the specific embodiments and examples described heretofore, and that many modifications and variations of the invention are possible within the scope of the invention.

### Reference Signs List

1: Wafer heating apparatus

3; Base member

5: Insulating layer

7: Bonding layer

9: First bonding layer

11: Second bonding layer

13: Uniform heating plate

15: Fillers

17: Heater electrode

21: Electrostatic chuck

22: Ceramic member

23: Adsorption electrode

1. A wafer heating apparatus, comprising:
a base member comprising an upper surface which is flat;
an insulating layer comprising a heater electrode embedded therein;
a uniform heating plate bonded to an upper surface of the insulating layer with an upper surface thereof being closer to a wafer; and
a bonding layer made of a filler-containing resin, configured to bond a lower surface of the insulating layer to the upper surface of the base member, wherein
the bonding layer comprises at least two layers of a first bonding layer on a base member side and a second bonding layer contacted with the insulating layer, and
the second bonding layer contains fillers with a flat-shape, the fillers being arranged to lie flat along a planar direction of the second bonding layer.

2. The wafer heating apparatus according to claim 1, wherein a ratio of an area of the fillers with a flat-shape constitutes 50 to 90% to an area of the second bonding layer when the second bonding layer is viewed in a plan view.

3. The wafer heating apparatus according to claim 1, wherein a density of the fillers in the second bonding layer is higher than a density of fillers in the first bonding layer.

4. The wafer heating apparatus according to claim 1, wherein the fillers with a flat-shape are arranged to overlap in part each other.

5. An electrostatic chuck, comprising:
the wafer heating apparatus according to claim 1; and
a ceramic member which is bonded to the upper surface of the uniform heating plate, comprises an adsorption electrode embedded therein and an upper surface thereof configured to be a wafer placement surface.

6. A method for manufacturing a wafer heating apparatus, comprising:
forming a first bonding layer by applying a first adhesive made of a resin containing fillers to an upper surface of a base member, the upper surface configured to be flat, and then curing the first adhesive;
applying a second adhesive made of a resin containing flat-shaped fillers to an upper surface of the first bonding layer;
placing an insulating layer comprising a heater electrode embedded therein on the second adhesive, and then keeping the insulating layer and the second adhesive in intimate contact with each other in a vacuum environment;
curing the second adhesive while applying pressure from an upper surface of the insulating layer in an atmosphere environment; and
bonding a uniform heating plate to the upper surface of the insulating layer.

7. The wafer heating apparatus according to claim 2, wherein a density of the fillers in the second bonding layer is higher than a density of fillers in the first bonding layer.

8. The wafer heating apparatus according to claim 2, wherein the fillers with a flat-shape are arranged to overlap in part each other.
